(19) United States
(12) Patent Application Publication
(10) Pub. No.: US 2026/0048814 A1
(43) Pub. Date: Feb. 19, 2026

(54) PROPULSION SYSTEM FOR USER-PROPELLED VEHICLES

(71) Applicant: Jessie Cortez, Homeland, CA (US)

(72) Inventor: Jessie Cortez, Homeland, CA (US)

(21) Appl. No.: 19/303,199

(22) Filed: Aug. 18, 2025

Related U.S. Application Data
(60) Provisional application No. 63/684,327, filed on Aug. 16, 2024.

(51) Int. Cl. B62M 6/70; B62M 6/90

(52) U.S. Cl. CPC B62M 6/70; B62M 6/90

(57) ABSTRACT

The present invention discloses a propulsion system that could be retrofitted to a user-propelled vehicle, such as a bicycle or kick scooter vehicle, primarily powered by the user's physical effort. The system is designed to capture and convert kinetic energy generated by the user's movements into electrical energy, which is used to assist in propelling the vehicle. The propulsion system comprises a first motor located near a wheel axle of a first wheel assembly at a front portion of the vehicle. The first motor captures and converts kinetic energy into low-voltage electrical energy. The low-voltage electrical energy is then boosted by a transducer and converted to alternating current (AC) by an inverter. The AC power is sent to a throttle module, which enables to control a second motor that assists in propelling the vehicle. The propulsion system enhances the vehicle's efficiency, providing additional propulsion based on the user's input.

### PRIORITY AND RELATED APPLICATIONS

This application claims priority to U.S. Provisional Application No. 63/684,327, filed on Aug. 8, 2024, the disclosure of which is incorporated by reference in its entirety

### TECHNICAL FIELD

The present disclosure relates generally to user-propelled vehicles, and more particularly, to a kinetic energy-based propulsion system for user-propelled vehicles.

### BACKGROUND

User-powered vehicles of many types have been developed and are in widespread use throughout the world. Such vehicles enjoy great popularity and have proven extremely useful for general recreation, sports, physical exercise, and utility. The most common user-powered vehicles are bicycles, tricycles, and various three-wheeled or four-wheeled pedaled variations intended for use on land.

User-powered vehicles attempt to enhance propulsion efficiency by incorporating mechanisms that capture and utilize the kinetic energy generated by the user's movements. User-powered vehicles, such as kick scooters, combine elements of traditional tricycles with the dynamic movement of skating. Kick scooters are designed to be propelled by the user's leg movements, incorporating a skating-like motion that engages the lower body muscles. This motion allows for a more fluid and dynamic riding experience, making the ride enjoyable.

Despite the benefits of user-propelled vehicles, propelling user-powered vehicles requires continuous physical exertion, which can quickly lead to fatigue, especially during longer rides. Further, user-powered vehicles rely entirely on the rider's physical strength, which restricts the distance that can be traveled as the rider may become exhausted after a short time of propelling.

Therefore, there is a need for a kinetic energy-based propulsion system for user-propelled vehicles.

### SUMMARY OF THE INVENTION

The present invention discloses a propulsion system for user-propelled vehicles. The propulsion system is retrofittable to a user-propelled vehicle that is primarily propelled by the user's physical effort. The propulsion system is configured to capture and convert the kinetic energy generated by the user's movements into electrical energy, which provides a positive power output to assist in propelling the vehicle.

For example, the vehicle includes a frame having a first portion and a second portion opposite to the first portion. The first portion comprises a first wheel assembly, and the second portion comprises a second wheel assembly. The vehicle further comprises a steering module extending from the first portion of the vehicle and a handle member connected to the steering module. The steering module and the handle member enable the user to steer and control the direction of the vehicle. The vehicle is propelled either by using pedals, similar to a bicycle, or by pushing off the ground with the user's leg, like a kick scooter vehicle.

The propulsion system comprises a first motor configured to capture kinetic energy from the user's movement to assist in propelling the vehicle. In one embodiment, the first motor is disposed proximal to a wheel axle at the first portion of the frame. As the vehicle is propelled, the rotation of the wheels generates mechanical energy, which is captured by the first motor. The first motor converts the mechanical energy into electrical energy. The first motor is configured to produce a low voltage.

The system further comprises at least one transducer connected to the first motor. The first motor is a stationary motor. The transducer is configured to receive and convert the low voltage into a higher voltage. The transducer is further configured to transmit the higher voltage to an AC power inverter (also referred to as an inverter). In an example, the higher voltage is transmitted to the inverter through an electrical cable. The inverter is configured to convert the higher voltage from direct current (DC) to alternating current (AC).

The inverter is further connected to a throttle module of the vehicle. For example, the inverter is further connected to a throttle module via an electrical cable. In one embodiment, the inverter is configured to supply the high voltage to the throttle module to drive the vehicle. The system further comprises a second motor mounted on the vehicle and capable of at least assisting in propelling the vehicle. In one embodiment, the second motor is disposed at the wheel axle at the second portion of the frame. The second motor is coupled to the throttle module. The throttle module allows the user to control and manage the power delivered to the second motor. The second motor is configured to convert the electrical energy into mechanical energy, which drives the rear wheel or load of the bicycle or e-bike. Thereby, the propulsion system provides additional propulsion and assists with movement based on the user's input.

### BRIEF DESCRIPTION OF THE DRAWINGS

FIG. 1 exemplarily illustrates a block diagram of a kinetic energy-based propulsion system for user propelled vehicles, according to an embodiment of the present invention.

FIG. 2 exemplarily illustrates a block diagram of a kinetic energy-based propulsion system for user propelled vehicles, according to another embodiment of the present invention.

FIG. 3 exemplarily illustrates a perspective view of the user propelled vehicle with the propulsion system, according to an embodiment of the present invention.

FIG. 4 exemplarily illustrates a side view of the user propelled vehicle with the propulsion system, according to an embodiment of the present invention.

FIG. 5 exemplarily illustrates a side view of the user propelled vehicle complete with a battery-powered Amplification monitor that demonstrates the amount of battery used via generation, according to an embodiment of the present invention.

FIG. 6 exemplarily illustrates a diagram of the side view of the electricity generation system and relationship with rear wheel, according to an embodiment of the present invention.

FIG. 7 exemplarily illustrates a side view of the user-propelled generator, according to an embodiment of the present invention.

FIG. 8 exemplarily illustrates a birds-eye view of the generator and wire system, according to an embodiment of the present invention.

FIG. 9 exemplarily illustrates a block diagram of the hub body method and its functionality, as well as its relation to the wheels.

### DETAILED DESCRIPTION OF THE INVENTION

Example embodiments of the disclosure will now be described more fully hereinafter with reference to the accompanying drawings, in which example embodiments are shown. The concepts discussed herein may, however, be embodied in many different forms and should not be construed as limited to the example embodiments set forth herein; rather, these embodiments are provided so that this disclosure will be thorough and complete and will fully convey the scope to those of ordinary skill in the art. Like numbers refer to like elements but not necessarily the same or identical elements throughout.

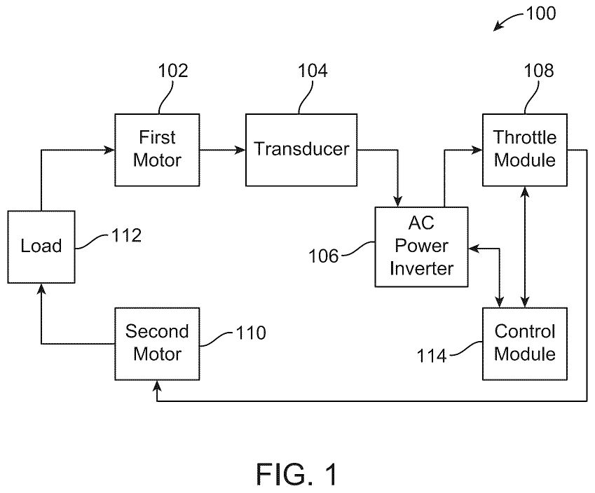

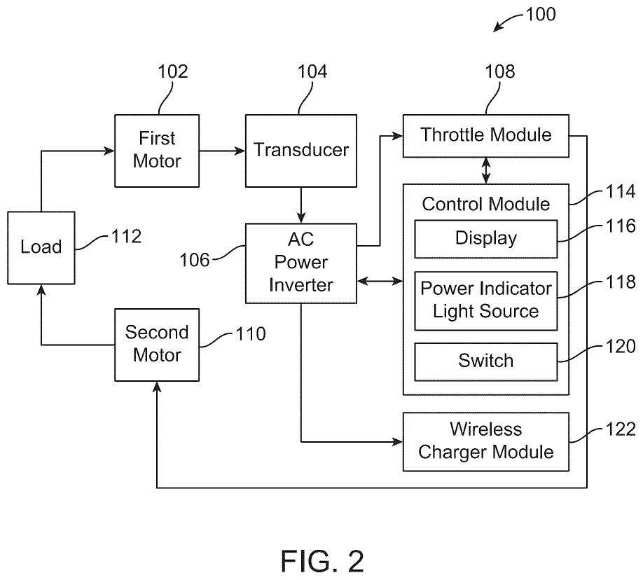

Referring to FIG. 1 and FIG. 2, a propulsion system 100 is retrofittable to a user-propelled vehicle that is primarily propelled by the user's physical effort. The propulsion system 100 is configured to capture and convert the kinetic energy generated by the user's movements into electrical energy, which provides a positive power output to assist in propelling the vehicle.

As used herein, the vehicle includes any form of user-powered vehicle and is not limited to any particular type. For example, the vehicle includes, but is not limited to, bicycles, kick scooters, skateboards, e-bikes, or any other vehicle. The propulsion system 100 could also be used with motorized vehicles and battery-powered vehicles.

For example, the vehicle includes a frame having a first portion and a second portion opposite to the first portion. The first portion comprises a first wheel assembly, and the second portion comprises a second wheel assembly. Each wheel assembly includes a wheel axle and wheels. The vehicle further comprises a steering module extending from the first portion of the vehicle and a handle member connected to the steering module. The steering module and the handle member enable the user to steer and control the direction of the vehicle. The vehicle is propelled either by using pedals, similar to a bicycle, or by pushing off the ground with the user's leg, like a kick scooter.

The vehicle is retrofitted with the propulsion system 100. The propulsion system 100 comprises a first motor 102 configured to capture kinetic energy from the user's movement to assist in propelling the vehicle. In one embodiment, the first motor 102 is disposed proximal to a wheel axle at the first portion of the frame.

As the vehicle is propelled, the rotation of the wheels generates mechanical energy, which is captured by the first motor 102. The first motor 102 converts the mechanical energy into electrical energy. The first motor 102 is configured to produce a low voltage.

The system 100 further comprises at least one transducer 104 connected to the first motor 102. The first motor 102 is a stationary motor. The transducer 104 is configured to receive and convert the low voltage into a higher voltage. The transducer 104 is further configured to transmit the higher voltage to an AC power inverter 106 (also referred to as inverter 106). In an example, the higher voltage is transmitted to the inverter 106 through an electrical cable. The inverter 106 is configured to convert the higher voltage from direct current (DC) to alternating current (AC).

The inverter 106 is further connected to a throttle module 108 of the vehicle. For example, the inverter 106 is further connected to the throttle module 108 via an electrical cable. In one embodiment, the inverter 106 is configured to supply the high voltage to the throttle module 108 to drive the vehicle. The system 100 further comprises a second motor 110 mounted on the vehicle and capable of at least assisting in propelling the vehicle. In one embodiment, the second motor 110 is disposed at a wheel axle at the second portion of the frame. The second motor 110 is coupled to the throttle module 108. For example, the second motor 110 is coupled to the throttle module 108 via an electrical cable. The throttle module 108 allows the user to control and manage the power delivered to the second motor 110.

The second motor 110 is configured to convert the electrical energy into mechanical energy, which drives the wheels or load 112 of the vehicle. Thereby, the propulsion system 100 provides additional propulsion and assists with the movement of the vehicle based on the user's input.

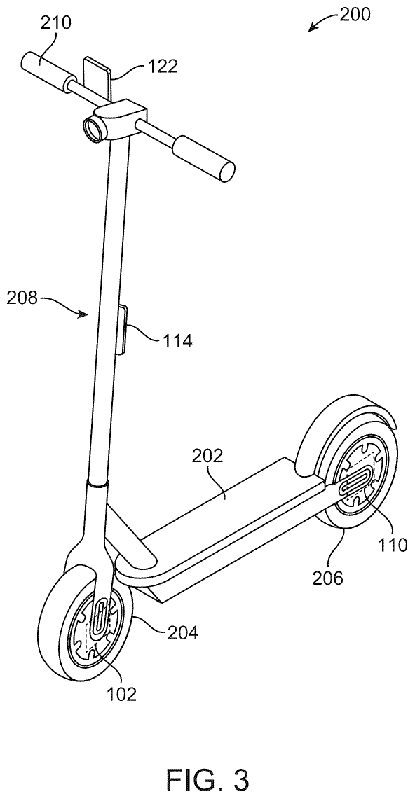

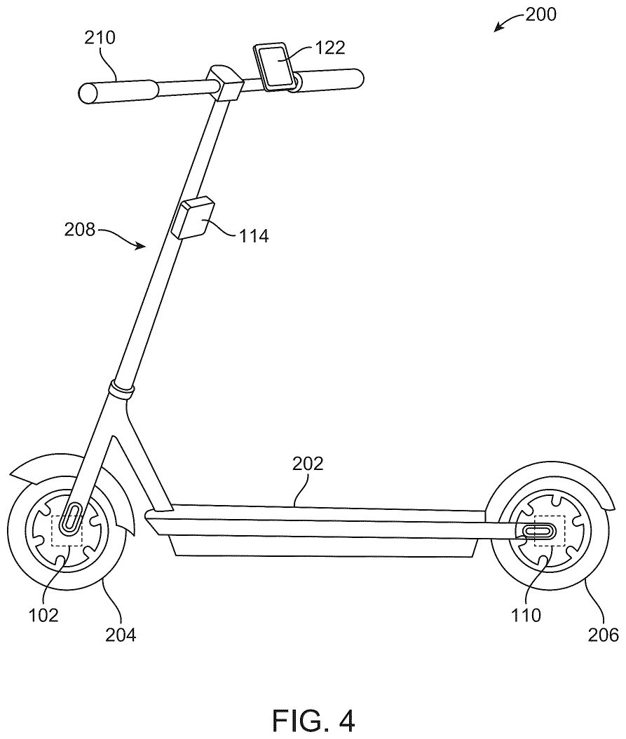

Referring to FIG. 3 and FIG. 4, a kick scooter vehicle 200 comprises a platform member 202, a first wheel assembly 204 at a front portion of a frame of the kick scooter vehicle 200, and a second wheel assembly 206 at a rear portion of the frame. The kick scooter vehicle 200 is also referred to as scooter vehicle 200. Each wheel assembly (204, 206) comprises at least one wheel disposed on a wheel axle. The scooter vehicle 200 further comprises a steering member 208 that extends upwardly from the top of the frame of scooter vehicle 200. Alternatively, the steering member 208 may be a straight vertical post or a telescoping post. The scooter vehicle 200 further comprises a handle 210 connected to the steering member 208. The handle 210 is disposed at a sufficient height to be grasped by a person standing upon the platform member 202. The kick scooter vehicle 200 further comprises the propelling system 100.

In the case of the kick scooter vehicle 200, the user stands on the platform member 202 and pushes against the ground with one foot to generate forward motion, which in turn allows the wheels to rotate and enables the maneuvering of the scooter vehicle 200.

The rotation of the wheels turns the first motor 102 at a low RPM and produces a low voltage. The system 100 further comprises at least one transducer 104 connected to the first motor 102. The transducer 104 is configured to receive and convert the low voltage into a higher voltage. For example, the transducer 104 is configured to boost the voltage up to around 15 volts.

The transducer 104 is further configured to transmit the higher voltage to the AC power inverter 106. The inverter 106 is configured to convert the higher voltage from direct current (DC) to alternating current (AC). The inverter 106 resonates that voltage and boosts the voltage from the low input level to a higher level, in this case, between 35 to 45 volts. This higher voltage is more suitable for powering the main electrical systems, such as the throttle module 108 or the second motor 110.

The power inverter 106 then sends the electrical current to the throttle module 108 on the handle 210. When the user engages the throttle module 108, the electrical current is directed to the second motor 110 in the rear hub wheel or second wheel assembly 206, which powers the scooter vehicle 200. As the second motor 110 drives the scooter vehicle 200 and turns the wheels, the stationary motor or the first motor 102 also continues to rotate and generate additional electrical voltage. The generated voltage is sent back to the transducer 104, which forwards the voltage to the power inverter 106, thereby creating a continuous loop of energy generation and usage.

Referring to FIG. 1 to FIG. 4, the system 100 further comprises a control module 114. The control module 114 enables the user to control the propulsion system 100. The control module 114 comprises a power indicator light source 118 and a switch 120 to turn on and off the system 100. In an embodiment, the power indicator light source 118 is a light-emitting diode, and the switch 120 is a toggle switch. In another embodiment, the control module 114 comprises a display 116 configured to indicate the availability of the power level to activate the throttle module 108. In another embodiment, the power indicator light source 118 is turned on to indicate the availability of the power level to activate the throttle module 108. The system 100 indicates the availability of power when the AC power inverter 106 receives the input voltage from the transducer 104.

The system 100 further comprises a wireless charger module 122, enabling the charging of a user device, for example, a smartphone. The wireless charger module 122 is connected to the AC power inverter 106. The wireless charger module 122 is further configured to hold the user device and wirelessly charge the user device as the user rides to the destination.

Advantageously, the system 100 could be integrated into existing battery systems to extend the range and lifespan of various devices. By helping to regenerate power back into the battery, the system 100 could enhance the performance of a wide range of applications, including scooters, bike conversion kits, electric bikes, drones, electric boats, electric vehicles, electric dirt bikes, electric personal watercraft, electric go-karts, electric All-Terrain Vehicles (ATVs), power tools, electric lawn equipment, robotics, generators, aircraft, and other systems. Additionally, the system 100 has the potential to be adapted for future experimental uses, including military applications.

In some exemplary embodiments, a system in accordance with the present invention may be a kit, designed to enable a retrofit of an existing scooter. For example, and without limiting the scope of the present invention, a propulsion system for an existing user-propelled scooter, may include a generator coupled to a wheel of a scooter, the generator adapted to store kinetic energy generated by a user; and a rechargeable battery coupled to the generator and a motor, wherein the rechargeable battery is adapted to extend a range of the motor by supplying power from the generator to the motor.

In some embodiments, the generator is housed separately than the motor. In some embodiments, the generator is housed together with the motor.

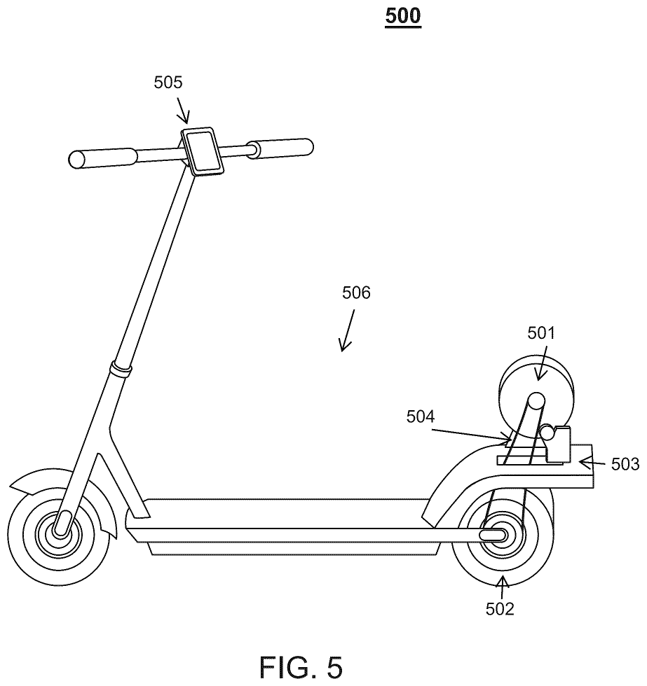

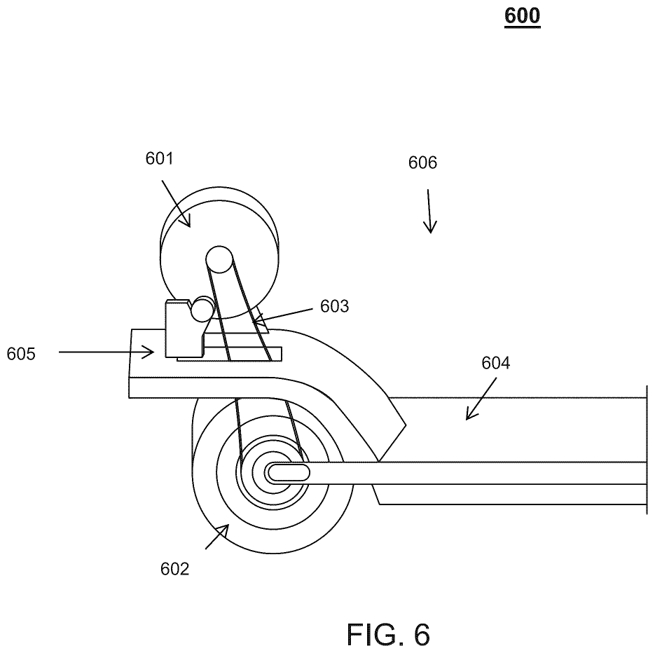

Accordingly, in some exemplary embodiments of the invention, referring to FIG. 5 and FIG. 6, a propulsion system 600 for a user-propelled scooter, may include a generator 601 coupled to a wheel 602 of a scooter 606, the generator 601 adapted to store kinetic energy generated by a user; a platform 604 for securing the generator over the wheel, a bracket 605; a band 603 mechanically connecting the generator to the wheel; and a rechargeable battery coupled to the generator, monitor 505, and a motor, wherein the rechargeable battery is adapted to extend a range of the monitor by supplying power from the generator to the motor.

In some embodiments, such as system 500, the generator 501 is situated specifically above the rear wheel of the scooter. FIG. 5 describes a propulsion system for a user-propelled scooter 506, comprising of a generator coupled to the wheel of a scooter; wherein the generator is adapted to store kinetic energy. The generator is coupled to the wheel, via a platform for securing the generator 501 over the wheel 502, wherein the wheel is the rear wheel of the user-propelled scooter; a bracket 503; and a band 504 mechanically connecting the generator to the rear wheel.

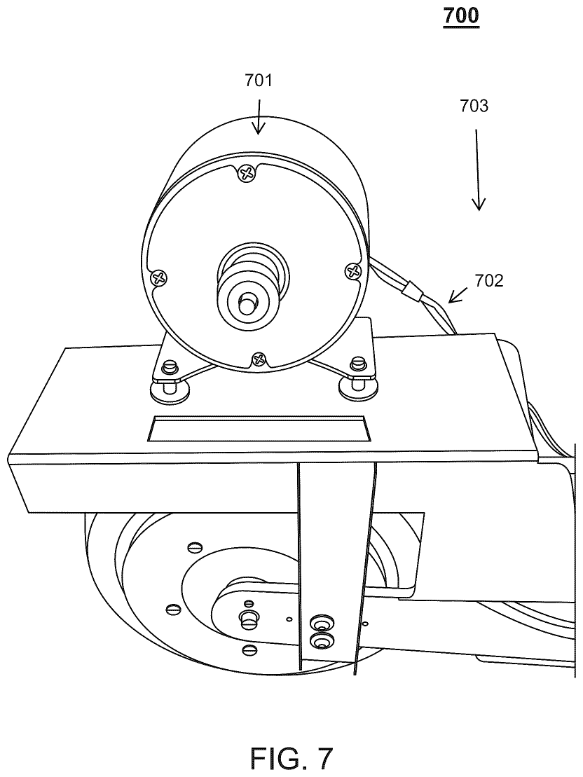

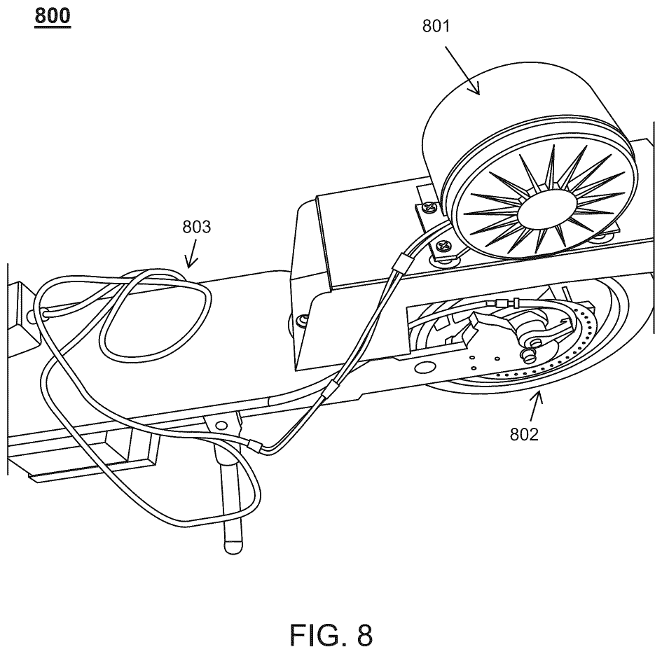

In some embodiments, such as FIG. 7 to FIG. 8, wherein each respective figure demonstrates a different view for a propulsion system for a user-propelled scooter 703 may comprise of a generator coupled to the wheel of the scooter, where the wheel can be the front or rear wheel, with the generator 701 adapted to store kinetic energy generated by a user, and a rechargeable battery 702 coupled to the generator and a motor 801, coupled to a wheel 802, wherein the rechargeable battery 803 is adapted to extend a range of the motor by supplying power from the generator to the motor.

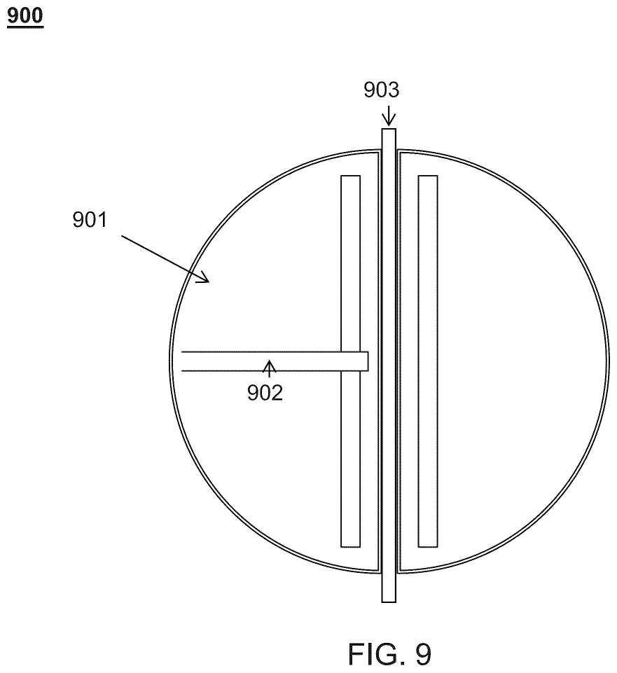

In other exemplary embodiments of the invention, such as FIG. 4 to FIG. 9, a propulsion system for a user-propelled scooter may include a generator coupled to the side of the wheel of a scooter, wherein the generator is adapted to generate power from kinetic energy provided by a user. A hub body 901 housing the generator and a motor is adapted to drive the wheels of the scooter; a rechargeable battery 114 is coupled to the generator and motor, wherein the rechargeable battery is adapted to extend a range of the motor by supplying power from the generator to the motor. In said embodiment, the hub body is coupled directly to the wheel of the scooter 903 via a rod 902 and can be coupled to either the front or back wheel of the user-propelled scooter.

The user-propelled scooter comprises of a monitor couple to the rechargeable battery and attached to one or more handles of the scooter, where the monitor is an amperage of the rechargeable battery. The monitor is adapted to display the parameter, additionally comprising of an LED indicator adapted to indicate a battery level of the user-propelled scooter.

Although the features, functions, components, and parts have been described herein in accordance with the teachings of the present disclosure, the scope of coverage of this patent is not limited thereto. On the contrary, this patent covers all embodiments of the teachings of the disclosure that fairly fall within the scope of permissible equivalents.

Many modifications and other implementations of the disclosure set forth herein will be apparent, having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

What is claimed is:

1. A propulsion system for a user-propelled scooter, comprising:
a generator coupled to a wheel of a scooter, the generator adapted to store kinetic energy generated by a user; and
a rechargeable battery coupled to the generator and a motor, wherein the rechargeable battery is adapted to extend a range of the motor by supplying power from the generator to the motor.

2. The system of claim 1, wherein the generator is secured above or adjacent to the wheel of the user-propelled scooter.

3. The system of claim 1, further comprising:
a hub body housing the generator and the motor adapted to drive the wheel of the scooter.

4. The system of claim 3, wherein the hub body is coupled directly to the wheel of the scooter.

5. The system of claim 2, wherein the generator is secured above the wheel.

6. The system of claim 2, wherein the wheel is a rear wheel of the user-propelled scooter.

7. The system of claim 6, further comprising:
a platform for securing the generator over the rear wheel.

8. The system of claim 7, further comprising:
a bracket; and
a band mechanically connecting the generator to the rear wheel

[symbol]

9. The system of claim 1, further comprising:
a platform for securing the generator over the wheel, wherein the wheel is a rear wheel of the user-propelled scooter;
a bracket; and
a band mechanically connecting the generator to the rear wheel.

10. The system of claim 1, further comprising:
a monitor coupled to the rechargeable battery and attached to one or more handles of the scooter, the monitor adapted to display a parameter of the rechargeable battery.

11. A propulsion system for a user-propelled scooter, comprising:
a generator coupled to a wheel of a scooter, the generator adapted to generate power from kinetic energy provided by a user;
a hub body housing the generator and a motor adapted to drive the wheel of the scooter; and
a rechargeable battery coupled to the generator and the motor, wherein the rechargeable battery is adapted to extend a range of the motor by supplying power from the generator to the motor.

12. The propulsion system of claim 11, wherein the hub body is coupled directly to the wheel of the scooter.

13. The propulsion system of claim 12, wherein the wheel is a rear wheel of the user-propelled scooter.

14. The propulsion system of claim 12, wherein the wheel is a front wheel of the user-propelled scooter.

15. The propulsion system of claim 1, further comprising:
a monitor coupled to the rechargeable battery and attached to one or more handles of the scooter, the monitor adapted to display a parameter of the rechargeable battery.

16. The propulsion system of claim 15, wherein the parameter displayed by the monitor is an amperage of the rechargeable battery.

17. The propulsion system of claim 15, wherein the monitor adapted to display the parameter comprises an LED indicator adapted to indicate a battery level of the user-propelled scooter.

18. A propulsion system for a user-propelled scooter, comprising:
a generator coupled to a wheel of a scooter, the generator adapted to store kinetic energy generated by a user;
a platform for securing the generator over the wheel, wherein the wheel is a rear wheel of the user-propelled scooter;
a bracket;
a band mechanically connecting the generator to the wheel; and
a rechargeable battery coupled to the generator and a motor, wherein the rechargeable battery is adapted to extend a range of the motor by supplying power from the generator to the motor.

19. The system of claim 2, wherein the generator is secured above the wheel.

20. The system of claim 1, further comprising:
a monitor coupled to the rechargeable battery and attached to one or more handles of the scooter, the monitor adapted to display a parameter of the rechargeable battery.
